(19) United States
(12) Patent Application Publication
(10) Pub. No.: US 2013/0014434 A1
(43) Pub. Date: Jan. 17, 2013

(54) Compositie delivery and nutrient system for agricultural and nursery uses

(71) Applicants: Patrick McGroarty, Bloomington, MN (US); James J. Quinn, Longboat Key, FL (US); Bryan M. McGroarty, Naples, FL (US)

(72) Inventors: Patrick McGroarty, Bloomington, MN (US); James J. Quinn, Longboat Key, FL (US); Bryan M. McGroarty, Naples, FL (US)

(73) Assignee: TegraSeal Products, LLC, Bloomington, MN (US)

(21) Appl. No.: 13/547,629

(22) Filed: Jul. 12, 2012

Related U.S. Application Data
(60) Provisional application No. 61/506,847, filed on Jul. 12, 2011.

(51) Int. Cl. A01G 13/02

(52) U.S. Cl. 47/32.8; 47/32.7

(57) ABSTRACT

A method and device for containing or encompassing the roots of the plant comprises a base sheet of material containing at least one selected area on the sheet facing the roots, the at least one selected area containing selected nutrients for promoting plant and/or root growth.

### FIELD OF THE INVENTION

The present invention relates to maintaining plants in a healthy state when the plant is stored at a nursery, during transportation, maintenance at a retail outlet or nursery and/or subsequent transplantation. In particular, this invention relates to selectively providing nutrients subterraneously to the plant thereby promoting root growth.

### BACKGROUND OF THE INVENTION

Growing, transporting, and transplanting plants has become a large industry. The suppliers and sellers of such plants to the consuming public need to provide plants that are healthy and once transplanted will grow to the satisfaction of the buyer. In order for this to be done, the plant must be maintained in a healthy environment during transportation, maintenance at a nursery or other retail establishment, and during transplantation. If the plant is not maintained in a healthy state, the buyer will be dissatisfied and may even ask for a refund or another new plant to replace the original plant purchased. It is important therefore to provide plants in the healthiest environment to the purchaser such that once the plant is transplanted, it grows to the satisfaction of the purchaser.

Many plants are transplanted and transported by surrounding the roots of the plant with a fabric, such as burlap, to form a ball structure. The quality and preparation of the root ball may very well determine how well the plant survives during transportation and transplantation. A typical scenario in transplanting a plant with a root ball is to leave the plant to its own survival once the root ball is placed in the planting hole. At best fertilizer is thrown into the hole or after the root ball is covered with dirt applied to the surface of the soil.

Hand sprinkling fertilizer or other plant nutrients into the planting hole results in a majority of the fertilizer and other nutrients falling to the bottom of the hole and therefore not being available to the root ball in a way that the root ball (plant roots) can uptake the fertilizer or other plant nutrients in an efficient manner. Throwing fertilizer onto the top surface of the soil may help a little more, but again, the fertilizer and/or other nutrients have to reach the roots efficiently for optimizing uptake by the plant.

### SUMMARY

This disclosure describes a method of promoting plant and/or root growth of a plant to be transplanted. The method comprises encompassing the roots of the plant within a base sheet of material containing at least one selected area on the base sheet facing the roots, the at least one selected area on the sheet containing selected nutrients for promoting plant and/or root growth

This disclosure also describes a device for containing plant roots and promoting plant and/or root growth. The device comprises a base sheet of material comprising at least one selected area on the base sheet facing the roots, the at least one selected area on the sheet comprising selected nutrients for promoting plant and/or root growth.

This disclosure further describes a plant suitable for transportation and transplantation. The plant comprises a root ball, whose roots are contained within a flexible fabric in the general form of a ball, the fabric comprising at least one area facing the roots of the plant, the at least one area including selected nutrients for promoting root growth and/or plant growth.

### DETAILED DESCRIPTION

Providing nutrients, air and water to newly planted, transplanted or transported plants is important for expecting a high survival rate as well as vigorous, uniform and sustained plant growth. Over the past decades, it has been clearly demonstrated that the total environment of the plant must be considered if these goals are to have a reasonable promise of attainment.

This disclosure describes a system of controlled nutrient delivery for plants. The system provides a predetermined and carefully measured quantity of nutrient, biological, organic and inorganic components to all plants intended to be planted, transplanted, or transported including trees, shrubs, vegetables, fruits, and flowers. Placement and adhesion of essential organisms on to a substrate are described. The substrate is composed of biodegradable (preferably) mesh such as burlap fabric, which is then wrapped around the roots of a plant and earth to form a “root ball.” The system described herein will “complete” nursery grown plants by introducing beneficial mycorrhiza (fungi), beneficial bacteria and other beneficial organic and inorganic components to the roots, which will be activated at the time of planting to provide the plants with a full, functioning system. For purposes of this application, such beneficial mycorrhiza (fungi), beneficial bacteria and other beneficial organic and inorganic components may be referred to as “inoculants”.

The system described in this disclosure presents the inoculants in a manner such that the nutrients are automatically delivered to the root system of the plant in an optimal manner. The system can also be used to create a “cocktail” of seed, fertilizer, inoculants, air entrainment and water storage materials which will “re-seed” open earth excavation while preventing soil erosion until the seeds germinate.

Another feature of this disclosure is to allow for the uniform inoculation, and even distribution around the root ball of biological components and organic fertilizers, which include mycorrhiza fungi and beneficial bacteria (nutrients). Other ingredients may be added or ingredients removed to create plant specific formulations. These materials create an environment that permits the establishment of a symbiotic relationship between mycorrhiza fungi and plant roots and promote the ability of the soil organisms to convert organic and inorganic compounds into a self sustaining source of continued plant nutrients. The even distribution of the inoculants assures uniform growth and a sustainable food supply.

The need to further nurture plants by modifying the soil itself is vital and best served by introducing “inoculants” of soil bacteria, fungi and other compounds, which are essential to the establishment of healthy plants by breaking down existing organic and inorganic compounds and converting them to a source of sustainable food. A self cyclic and nourishing environment has to be created to produce a thriving and healthy plant for sale. Such a healthy plant is the result of placing the proper biological components in controlled amounts in the proper location, and with an adequate and uniform supply of water and air so that the plant roots can uptake in an optimal fashion. All of the following must be considered and accommodated if there is to be a high degree of healthy plants for sale to buyers:
Blend of standard “fertilizers”;
Controlled location and uniform water and air storage capacity of surrounding soil;
The precise selective placement of soil “inoculants” to assist the plant's ability to associate symbiotically with organisms in the ground to reduce susceptibility to disease, provide fertilizer and water storage needs and to utilize the soil's natural organic and inorganic compounds by converting them to long as well as short term sources of food; and
Careful control of the quantity and uniform placement of vital biological components are designed to nurture the plant through early growth and establishment.

Bacteria are a vital additive in sustaining root growth and enhancing biological activity, the benefits of which include but are not limited to;
Promoting nutrient solubilization and mineralization;
Enhancing nutrient uptake;
Enhancing photosynthetic capacity and reducing supplemental Nitrogen, Phosphorus and Potassium requirements;
Bacteria contain L-Cystene, L-Glycine, L-Glutamate to facilitate production of Glutathione, a potent abiotic Stress Reducer;
Bacteria contain L-Tryptophan to facilitate production of Indole Acetic Acid (IAA), a natural phyto-hormone responsible for triggering flowering mechanism; and
Bacteria that contain high concentrations of sugars which supplement plant's increased requirement during the flowering phase.

In current nursery production the root to plant symbiosis of beneficial and essential fungi and bacteria does not exist due to the intense management aimed at growing plants to specific physical specifications. Most nursery production follows the American Standard Nursery Stock, a specification almost entirely focused on the physical aspects of plant growth and production. In fact, the document, which is 129 pages in length, does not mention the word “healthy” until page 36. Plants and their roots that are grown in production nurseries have not developed the symbiotic relationships with natural fungi and bacteria.

This disclosure also describes a method for making a root ball that maintains the health of a plant during transport and at a nursery and once planted continues providing the plant with nutrients to enhance its growth. Burlap is an exemplary material for surrounding the roots of a plant in a ball formation. The burlap that has been used is a coarse, loosely woven, fabric made from Jute or similar type plant material. Jute is plant fiber derived from plants belonging to the genus Corchorus. Such fiber is well-known and is second only to cotton in amount produced. Since the material is plant derived, it is inherently biodegradable. Burlap fabric is a basic component for almost all packaging of field-grown plants intended for transplant because burlap confines and contains the soil. Containing the soil around the root system minimizes “shock” to the plant during digging the plant up from its initial growth area and then during transportation. Burlap is flexible thereby permitting formation of a ball around the plant roots. The burlap is cut to size in order to accommodate varying root ball sizes.

The burlap is buried when the plant is transplanted again minimizing disturbing the soil around the roots and continuing the friendly environment in which the root system was transported. Once the plant is transplanted, burlap permits the roots to grow through the burlap while the burlap slowly biodegrades during this stage of the growth all the while keeping the root ball intact. The burlap through its inherent properties minimizes disturbance of the plant's roots.

The burlap base material provides a stable and flexible attachment base or substrate for the adhesive and blended nutrients that are part of this disclosure. Other materials besides burlap may be used. Such materials should contain the attributes of burlap that are described herein such as biodegradability, flexibility, permitting roots to grow through after transplantation and the ability to retain and hold nutrients in selected positions such that the nutrients are presented to the plant roots in a manner that optimizes plant growth and health.

The base material is modified to retain the nutrients at selected positions. An adhesive emulsion base material is sprayed on the base material. The adhesive emulsion is, for example, an adhesive of biodegradable materials such as carboxyl methyl cellulose modified with sucrose or starch. Additionally, an acrylic emulsion has proven acceptable as an adhesive for the production needs of the system.

Once prepared with a layer of the adhesive, a layer of blended nutrients or a fertilizer mixture is next deposited on the adhesive emulsion base material. For example, the fertilizer mixture can comprise beneficial fungi, beneficial bacteria and additional beneficial organic and inorganic compounds. The fertilizer mixture of essential organisms includes beneficial fungi which can be, but are not limited to;
Diverse multi strains endomycorrhiza;
Diverse multi-strains ectomycorrhiza; and
Diverse multi-strains Trichoderma;
   and/or beneficial bacteria which can be, but is not limited to
Bacillus firmus;
Bacillus amyloliquefaciens;
Bacillus subtilis;
Bacillus licheniformis;
Bacillus megaterium;
Bacillus pumilus;
Bacillus azotoformans;
Bacillus coagulans;
Geobacillus stearothermophilus;
Paenibacillus polymyxa;
Paenibacillus durum;
Pseudomonas aureofaceans;
Pseudomonas fluorescence;
Pseudomonas putida;
Streptomyces coelicolor;
Streptomyces lydicus; and
Streptomyces griseus;
   and/or beneficial organic and inorganic components which can be but no limited to;
Humic acid;
Amino acids;
Proteins;
Vitamin B Complex;
Sea kelp extract; and
Polyacrylamide copolymer superabsorbent

For example, the following amounts of beneficial bacteria have proven to be effective;
100,000,000 Colony Forming Unit (CFU) per gram of the following organisms; Bacillus firmus, Bacillus amyloliquefaciens, Bacillus subtilis, Bacillus licheniformis, Bacillus megaterium, Bacillus pumilus, Bacillus coagulans, Geobacillus stearothermophilus, Paenibacillus polymyxa, and Paenibacillus durum;
100,000,000 CFU per lb of Bacillus azotoformans; and
20,000,000 CFU per gram of Pseudomonas aureofaceans and Streptomyces lydicus, 22,000,000 CFU per gram of Pseudomonas fluorescence, Pseudomonas putida, and Streptomyces coelicolor, Streptomyces griseus, Trichoderma reesei, Trichoderma hamatum, Trichoderma harzianum.

Other materials that may be added to create “plant specific” formulations include iron, calcium compounds, and organic fertilizers. These compounds will vary with the target plant and will be tailored to maximize establishment of a symbiotic mycorrhizal association. Inert particulate substances such as heat-treated vermiculites and/or perlite aerate the soil and optimize essential root respiratory processes, and so these “aerators” are also included in the mixture for maximum effectiveness.

The predetermined nutrient mixture is adhered in a dry and unaltered form to the burlap mesh fabric by the adhesive emulsion base material to form a tough permeable layer of dry nutrients typically equally dispersed over the entire surface of the burlap wrapping material. For example, the amount of each ingredient is carefully measured and uniformly distributed over the entire surface. Alternatively, each ingredient may be distributed to selected individual or controlled areas of the base in order to target different nutrient contact with different areas of the root ball/root system.

This procedure is repeated until a sufficient (effective) amount of biological organic, and inorganic components is deposited to form a composite product sheet. After manufacture, the composite product sheet may be further processed to form virtually any shape needed for the particular root system of the plant and/or for marketing purposes or convenience to the customer. Such shapes include but are not limited to sleeves, socks, or bags designed to hold the roots of various plants for transport, transplant, storage, or point-of-sale presentation to the buyer. The sleeves, socks and bags are designed to hold the roots of a plant during transport, watering, storage and planting cycles.

Alternatively, the fertilizer mixture can be applied to targeted portions of the burlap depending on the needs of the plant species/variety. The mixture can be adjusted depending on the specific needs of the individual plant species/variety. The system allows for easily customized formulations to assist the plant's survival and prosperity in varied climates and/or soil conditions. For example, the amount of SAPs (super absorbent polymers) may be increased when planting in highly permeable soils (sand) and may be permanently enhanced by the addition of sodium montmorillonite clay (Bentonite), thus decreasing the permeability and increasing the water retention of the soil. Such a system is may then be “locked in” place by a final layer of a degradable adhesive polymer on a side of the nutrient system opposite from the burlap base material.

The flexibility of the biodegradable burlap holds the soil firmly in place while holding the nutrients completely around the root ball and permitting water to enter the root ball and be retained by for example by SAP. The system of the present invention thus prevents erosion while watering the plant during transport and storage prior to sale by holding the soil, roots and nutrients in place. Additionally, the system of this disclosure also allows the growing roots to easily grow through and into the surrounding soil once the plant has been permanently transplanted in the ground.

Similarly, tubes of paper, plastic and other composites may be used as base material to accomplish the even distribution of biological, organic, and other components in growing systems where plants are grown in cells, flats, containers, drums, boxes, and other configurations and a “sleeve” containing evenly distributed previously mentioned fertilizers, inoculums, super water absorbers, fungi, bacteria, etc. that are used to enhance plant health and growth. As with the burlap base material described previously, an adhesive layer is applied to the paper, plastic, or other composite that is used as the base material and the cocktail of nutrients is then applied continuously or in selected positions on the base material. The roots of the plant that are contained within the tube of paper, plastic, or other composite material can then partake in an optimal and efficient manner of the nutrient cocktail. It has been shown that plants grown in such an environment are much larger and healthier when compared to plants grown in a typical prior art growing container.

Although the present invention has been described with reference to preferred embodiments, workers skilled in the art will recognize that changes may be made in form and detail without departing from the spirit and scope of the invention.

What is claimed is:

1. A method of promoting root growth of a plant to be transplanted, the method comprising:
Encompassing the roots of a plant within a base sheet of material containing at least one selected area on the sheet facing the roots, the at least one selected area on the sheet containing selected nutrients for promoting plant or root growth.

2. The method of claim 1 wherein the base sheet of material is a fabric.

3. The method of claim 1 wherein the fabric comprises jute.

4. The method of claim 1 wherein the fabric comprises an adhesive layer in the one selected area with the selected nutrients being attached to the adhesive layer.

5. The method of claim 4 wherein the adhesive layer comprises carboxyl methyl cellulose.

6. The method of claim 1 wherein the selected area is determined by the nutrient needs of the plant species.

7. The method of claim 1 wherein the selected area is substantially continuous throughout the fabric forming the root ball.

8. The method of claim 1 wherein the nutrient layer comprises fertilizer, ectomycorrhiza fungi, Trichoderma fungi, Bacillus firmus, Bacillus amyloliquefaciens, Bacillus subtilis, Bacillus licheniformis, Bacillus megaterium, Bacillus pumilus, Bacillus azotoformans, Geobacillus stearothermophilus, Paenibacillus polymyxa, Paenibacillus durum, Pseudomonas aureofaceans, Pseudomonas fluorescence, Pseudomonas putida, Streptomyces coelicolor, Streptomyces lydicus, Streptomyces griseus, Humic acid, Amino acids, Proteins, Vitamin B Complex, Sea kelp extract, Polyacrylamide copolymer superabsorbent or any combination thereof.

9. The method of the claim 1 and further comprising placing the base sheet material encompassing the roots subterraneously.

10. The method of claim 1 wherein the base sheet material comprises paper or plastic.

11. The method of claim 10 wherein the paper or plastic is in the form of a growing container for a plant.

12. The method of claim 10 wherein the paper or plastic is in the form of a sleeve suitable for placement within a growing container for a plant.

13. A device for containing plant roots, the device comprising:
A base sheet of material comprising at least one selected area on the base sheet facing the roots, the at least one selected area on the sheet comprising selected nutrients for promoting plant or root growth.

14. The method of claim 13 wherein the base sheet of material is a fabric.

15. The method of claim 13 wherein the fabric comprises jute.

16. The method of claim 13 wherein the fabric comprises an adhesive layer in the one selected area with the selected nutrients being attached to the adhesive layer.

17. The method of claim 16 wherein the adhesive layer comprises carboxyl methyl cellulose.

18. The method of claim 13 wherein the selected area is determined by the nutrient needs of the plant species.

19. The method of claim 13 wherein the selected area is substantially continuous throughout the fabric forming the root ball.

20. The method of claim 13 wherein the nutrient layer comprises fertilizer, ectomycorrhiza fungi, Trichoderma fungi, Bacillus firmus, Bacillus amyloliquefaciens, Bacillus subtilis, Bacillus licheniformis, Bacillus megaterium, Bacillus pumilus, Bacillus azotoformans, Geobacillus stearothermophilus, Paenibacillus polymyxa, Paenibacillus durum, Pseudomonas aureofaceans, Pseudomonas fluorescence, Pseudomonas putida, Streptomyces coelicolor, Streptomyces lydicus, Streptomyces griseus, Humic acid, Amino acids, Proteins, Vitamin B Complex, Sea kelp extract, Polyacrylamide copolymer superabsorbent or any combination thereof.

21. The method of claim 13 wherein the base sheet material comprises paper or plastic.

22. The method of claim 21 wherein the paper or plastic is in the form of a growing container for a plant.

23. The method of claim 21 wherein the paper or plastic is in the form of a sleeve suitable for placement within a growing container for a plant.

24. A plant suitable for transportation and transplantation, the plant comprising a root ball having roots contained within a flexible fabric in the general form of a ball, the fabric comprising at least one area facing the roots of the plant, the at least one area including selected nutrients for promoting root growth or plant growth.

25. The plant of claim 24 wherein the fabric comprises jute.
